(19) United States
(12) Patent Application Publication
(10) Pub. No.: US 2014/0193110 A1
(43) Pub. Date: Jul. 10, 2014

(54) Grease Composition and Wheel Supporting Rolling Bearing Unit Having Grease Composition Packed Therein

(71) Applicant: NSK LTD, Shinagawa-ku, Tokyo (JP)

(72) Inventors: Kazuhiro Soga, Fujisawa-shi (JP); Takayuki Miyagawa, Fujisawa-shi (JP); Noriyuki Inami, Fujisawa-shi (JP)

(21) Appl. No.: 13/824,241

(22) PCT Filed: Sep. 18, 2012
(86) PCT No.: PCT/JP2012/005940

§ 371 Date: Mar. 15, 2013

(30) Foreign Application Priority Data
Sep. 26, 2011 (JP) 2011-209410
Jun. 8, 2012 (JP) 2012-130636

(51) Int. Cl. F16C 33/66; C10M 169/06

(52) U.S. Cl. CPC F16C 33/6633; C10M 169/06
USPC 384/462; 508/439

(57) ABSTRACT

There is provided a grease composition decreasing the load sensitivity to a running torque, maintaining necessary performances for a wheel supporting rolling bearing unit, and maintaining a good lubricated condition for a long time, and, a wheel supporting rolling bearing unit having the grease composition packed therein. The grease composition contains base oil, thickeners, rust inhibitors, and anti-wear agents, the base oil contains mineral oil, synthetic oil or blend oil of the mineral oil and the synthetic oil, a mix ratio (mass ratio) of the mineral oil and the synthetic oil is 0:100 to 20:80, a kinematic viscosity of the base oil at a temperature of 40° C. is 70 to 150 mm²/s, and a pour point of the base oil is equal to or lower than −40° C. The wheel supporting rolling bearing unit is packed with this grease composition.

### TECHNICAL FIELD

The present invention relates to a grease composition and a wheel supporting rolling bearing unit having the grease composition packed therein, and more specifically, to a grease composition which is packed in a bearing with a rolling element and a raceway surface being used under a high rolling element load (high contact pressure) condition, and which can keep the running torque (rolling friction coefficient) of a bearing down under a high rolling element load condition, and a wheel supporting rolling bearing unit for supporting a wheel rotatably with a suspension of an automobile.

### BACKGROUND ART

As a wheel supporting rolling bearing unit, for example, Patent Document 1 discloses its structure in FIG. 4. This wheel supporting rolling bearing unit 100 is a so-called third-generation inner-ring-rotating type undriven wheel unit, has a flange for fastening an outer ring 102 to a suspension, not illustrated, and formed at an outer diameter of the outer ring 102 that is a stationary ring, and has, at the inner diameter side, a hub 107 that is a rotational ring supported in a freely rotatable manner by a plurality of balls 105 that are rolling elements.

FIG. 4 illustrates balls as the example rolling elements 105; however, rollers may be used instead in the case of wheel supporting rolling bearings for heavy-weight vehicles.

Hence, outer double row raceways 110a, 110b that are each a stationary raceway are provided on the inner circumferential surface of the outer ring 102, and a first inner raceway 121 and a second inner raceway 122 that are each a rotational raceway are provided on the outer circumferential surface of the hub 107.

The hub 107 is a combination of a hub main body 103 and an inner ring 104. In those members, a hub flange 111 for supporting the wheel is provided on an outboard end part of the outer circumferential surface of the hub main body 103, and a small-diameter stepped portion 125 having a smaller diameter than that of a part where the first inner raceway 121 is formed is provided at a center portion near the inboard end.

Herein, the term “inboard” relative to an axial direction means a side near the center of the width direction of a vehicle in an assemble condition to the vehicle, and is, for example, the right side in FIG. 4. Conversely, a side which is the left side of FIG. 4 and near the external space of the vehicle in the width direction is referred to as “outboard” relative to the axial direction.

The inner ring 104, having the second inner raceway 122 with a substantially arcuate cross section on its outer circumferential surface, is externally fitted onto the small-diameter stepped portion 125.

Furthermore, the inboard end face of the inner ring 104 is held down by a caulking part 126 formed by causing the inboard end part of the hub main body 103 to be plastically deformed outwardly of the radial direction to fasten the inner ring 104 to the hub main body 103, and preload is applied to a bearing unit employing a back to back duplex bearing (DB arrangement) structure, thereby maintaining a high rigidity against road reaction that is applied as moment load.

Note that instead of the caulking part 126, a male screw may be formed on the inboard end part of the hub main body 103, and the inboard end face of the inner ring 104 may be held down and fastened by a nut.

A seal ring 106 is provided between the inner circumferential surface of the outboard end part of the outer ring 102 and the outer circumferential surface of the middle part of the hub main body 103, and a cap 108a is provided on the inboard end face of the outer ring 102, thereby sealing, from the external space, an internal space 117 which is a space between the inner circumferential surface of the outer ring 102 and the outer circumferential surface of the hub 107 and in which the respective balls 105, 105 are provided.

Grease is packed in the internal space 117, thereby lubricating rolling portions of the respective outer raceways 110a, 110b, the first inner raceway 121, the second inner raceway 122, and the respective balls 105, 105.

The explanation was given of the wheel supporting rolling bearing unit 100 with reference to the example so-called third-generation undriven wheel unit. However, a third-generation driving wheel units are also widely used which has a female spline formed at the bore of the hub main body 103 and engageable with the spline of a constant velocity joint, and which has the cap 108a replaced with a seal ring, and so-called first-generation and second-generation wheel supporting rolling bearing units are also used.

Improvements are desired for such bearings in accordance with the recent trend of energy saving, and for example, Patent Document 1 proposes a wheel supporting rolling bearing unit which utilizes a grease with a kinematic viscosity of 5.0×10⁻⁶ to 9.0×10⁻⁶ m²/s (5 to 9 cSt) at a temperature of 100° C. to reduce the rolling resistance of the rolling contact part, thereby reducing the running torque, and which improves the driving performance of the vehicle typical of an acceleration performance and a fuel mileage.

### PRIOR ARTS

### Patent Documents

Patent Document 1: JP 2003-239999 A

### SUMMARY OF THE INVENTION

### Problem to be Solved

However, since the wheel supporting rolling bearing units are applications that supports heavy load (that reaches, for example, the rolling element load (contact pressure) corresponding to the basic static load rating of the bearing at a turning acceleration of 0.8 G or so) at a slow rotational speed of several hundreds rpm (e.g., 800 rpm≈about 100 km/h), it is difficult to ensure a sufficient oil film thickness to get the elasto-hydrodynamic lubrication, and such units are normally used in a boundary lubrication condition. Accordingly, although the grease (the base oil has a lower viscosity than conventional technology) disclosed in Patent Document 1 is effective to some level for a torque reduction under a lower load and higher rotation condition like a fast-speed straight driving condition, in a normal use condition (medium and slow speeds, or a slight turning condition), in fact, the oil film thickness is reduced, which does not always result in a reduction of torque. Besides, it is likely to cause abnormal noises due to the rough surface cause by the metal contact of the raceway and the rolling elements.

Moreover, the wheel supporting rolling bearing units support the mass of the vehicle through wheels, as road reaction (e.g., radial, thrust, and moment load) input variably from the road surface through the tire in accordance with the driving condition of the vehicle.

When the rigidity of the wheel supporting rolling bearing unit is low, a camber angle changes in accordance with a change in the road reaction, the driving stability (steering performance and stability) is likely to be poor (unstable). Hence, the wheel supporting rolling bearing units are given a high rigidity by an application of preload in combination with the back to back duplex bearing structure.

In recent years, due to the improvement of the performance of vehicles and the extension of highways, etc., the rigidity required for the wheel supporting rolling bearing units tends to increase, and higher preload is often set in association with such tendency, and thus the running torque tends to increase.

On the other hand, natural resource saving and energy saving become requisite from the standpoint of the global environment protection, and the permitted mass (size) of the wheel supporting rolling bearings and running torque thereof tend to decrease, and thus there is a need for addressing conflicting disadvantages that are high rigidity and downsizing and torque reduction.

In addition, the wheel supporting rolling bearing units are sometimes subjected to long-distance transport of a brand new vehicle after assembled with the vehicle in a condition of receiving only vibration without rotating wheels.

Hence, as illustrated in FIG. 4, a fretting worn phenomenon of the balls and the raceway surface that is called false brinelling is likely to occur between the rolling elements 105, the outer raceways 110a, 110b, the first inner raceway 121, and the second inner raceway 122.

When the false brinelling occurs, the life of the bearing unit is reduced and uncomfortable vibrations and noises are produced. An example first countermeasure against the false brinelling is to increase the preload of the bearing unit, suppress a change in the area of a contacting ellipse by vibration, and suppress minute slippage produced between the ball and the raceway surface. However, as explained above, the increase of the preload results in the increase of the running torque, and an excessive increase of the preload results in the reduction of the bearing life, and thus it is difficult to increase the preload over a moderate level.

On the other hand, an example second countermeasure against false brinelling is to use an urea-thickener grease which has a larger base oil separation than a lithium soap thickener that is conventionally a typical grease as a wheel grease (or chassis grease), and lubricate the gap between the balls and the raceway surface by the separated base oil. However, when the base oil is excessively separated, oil leakage occurs from a seal, and the lubricity as the grease decreases.

The present invention has been made in view of the above-explained problems, and it is an object of the present invention to provide a grease composition which decreases the load sensitivity to the running torque of a wheel supporting rolling bearing unit (decreases a correlation coefficient between the rolling element load and the torque) to accomplish a reduction of torque, maintains necessary performances (e.g., fretting resistant performance, water resistance, and leakage prevention performance) for the wheel supporting rolling bearing unit, and can maintain a good lubricated condition for a long time, and, a wheel supporting rolling bearing unit having the grease composition packed therein.

### Solution to the Problem

To address the above-explained disadvantages, the inventors of the present invention keenly studied and found that by setting a suitable combination of mainly a base oil and a thickener, the load sensitivity to the running torque of a wheel supporting rolling bearing unit can be reduced (a correlation coefficient between rolling element load and torque can be reduced) to accomplish low torque, necessary performances (e.g., fretting resistant performance, water resistance, and leakage prevention performance) for the wheel supporting rolling bearing unit can be maintained, and a good lubrication condition for a long time.

The present invention has been made based on the above-explained finding by the inventors of the present invention, and a grease composition according to an aspect of the present invention to address the above disadvantage is a grease composition that includes base oil, thickeners, rust inhibitors, and anti-wear agents.

The base oil includes a mineral oil, synthetic oil or blend oil of the mineral oil and the synthetic oil, and a mix ratio (mass ratio) of the mineral oil and the synthetic oil is 0:100 to 20:80. A kinematic viscosity of the base oil at a temperature of 40° C. is 70 to 150 mm²/s, and the base oil has a pour point equal to or lower than −40° C.

The thickener may contain a diurea compound at a content rate of 10 to 40 mass % relative to a total amount of the grease composition and expressed by a following general formula (I), or a diurea compound at a content rate of 10 to 30 mass % relative to a total amount of the grease composition and expressed by a following general formula (II),

the rust inhibitor may contain a carboxyl-acid-based rust inhibitor, a carboxylate-based rust inhibitor, and an amine-based rust inhibitor, and

the anti-wear agent may be triphenyl-phosphorothioate.

R₂—NHCONH—R₁—NHCONH—R₃ General Formula (I)

(in the general formula (I), R₁ is aromatic-series hydrocarbon group with a carbon number of 6 to 15, and R₂ and R₃ are aromatic-series hydrocarbon groups with a carbon number of 6 to 12. R₂ and R₃ may be consistent or different from each other).

R₅—NHCONH—R₄—NHCONH—R₆ General Formula (II)

(in the general formula (II), R₄ is aromatic-series hydrocarbon group with a carbon number of 6 to 15, and R₅ and R₆ are aliphatic hydrocarbon group with a carbon number of 6 to 20 or cyclohexyl derivative group with a carbon number of 6 to 12. R₅ and R₆ have a rate of cyclohexyl derivative group that is 50 to 90 mol % in the total amount of the thickener, and R₅ and R₆ may be consistent or different from each other).

When the base oil having a pour point of equal to or lower than −40° C., a kinematic viscosity of 70 to 150 mm²/s, and a mix ratio (mass %) of a mineral oil and a synthetic oil that is 0:100 to 20:80, and the thickener which is a diurea compound and which has a content amount of 10 to 40 mass % are contained, the low-temperature fluidity and the wear performance become excellent, and thus a grease composition can be provided which has excellent low-temperature fretting characteristic and low torque characteristic.

Since the thickener containing the aromatic-series diurea compound expressed by the above-explained general formula (I) is contained at 10 to 40 mass % relative to the total amount of the grease composition, an excellent low leakage performance when packed in a bearing can be obtained, and when the three kinds of rust inhibitors that are a carboxyl-acid-based rust inhibitor, a carboxylate-based rust inhibitor, and an amine-based rust inhibitor, and an anti-wear agent that is triphenyl-phosphorothioate are contained, a robust surface protecting film can be formed, and thus a grease composition can be provided which has excellent peeling resistance, wear resistance, fretting resistant performance, and corrosion resistance.

When a metal contact between balls and a raceway surface is avoided as much as possible within a range of a use temperature (e.g., −40° C. to 160° C.) as a wheel supporting rolling bearing unit assembled with a vehicle, a low torque characteristic can be realized while the durability and the anti-friction performance are maintained.

Moreover, the fretting resistant performance and the wear resistance are accomplished within a range of atmosphere temperature (e.g., −40° C. to 50° C.) when a new car is transported, thereby suppressing an occurrence of false brinelling. Furthermore, a grease composition can be provided which has an excellent water resistance that is a requisite performance to a wheel supporting rolling bearing unit used in a mud water environment.

Since the thickener containing a diurea compound that is at least either one of alicyclic diurea compound and aliphatic diurea compound expressed by the above-explained general formula (II) is contained at 10 to 30 mass % relative to the total amount of the grease composition, a grease composition can be provided which has excellent low-temperature fretting characteristic and low torque characteristic. Moreover, by containing three kinds of rust inhibitors that are a carboxyl-acid-based rust inhibitor, a carboxylate-based rust inhibitor, and an amine-based rust inhibitor, and an anti-wear agent, a grease composition can be provided that has excellent peeling resistance, wear resistance, and corrosion resistance.

A wheel supporting rolling bearing unit according to an aspect of the present invention has any of the above-explained grease composition packed therein. According to such a structure, it becomes possible to provide a wheel supporting rolling bearing unit which decreases the load sensitivity to the running torque, maintains the necessary performances for the wheel supporting rolling bearing unit, and can maintain a good lubrication condition for a long time.

### Advantageous Effects of the Invention

According to the present invention, there are provided a grease composition and a wheel supporting rolling bearing unit having the grease composition packed therein, which decrease the load sensitivity to the running torque, maintain necessary performances for a wheel supporting rolling bearing unit, and maintain a good lubricated condition for a long time.

### BRIEF DESCRIPTION OF THE DRAWINGS

FIGS. 1A to 1D are cross-sectional views illustrating a wheel supporting rolling bearing unit according to an embodiment of the present invention applied as a third-generation hub unit bearing;

FIGS. 2A to 2E are cross-sectional views illustrating a wheel supporting rolling bearing unit according to an embodiment of the present invention applied as a first-generation hub unit bearing;

FIGS. 3A to 3H are cross-sectional views illustrating a wheel supporting rolling bearing unit according to an embodiment of the present invention applied as a second-generation hub unit bearing;

FIG. 4 is a cross-sectional view illustrating a third-generation undriven wheel hub unit bearing that is an example conventional wheel supporting rolling bearing unit; and

FIG. 5 is a graph illustrating a relationship between a rust inhibitor blending amount and total acid number in a first example of a wheel supporting rolling bearing unit according to an embodiment of the present invention.

### DESCRIPTION OF EMBODIMENTS

An explanation will be below given of an embodiment of a grease composition according to an aspect of the present invention and that of a wheel supporting rolling bearing unit having the grease composition packed therein with reference to drawings.

### (Grease Composition)

A grease composition according to an embodiment contains base oil, thickeners containing diurea compounds, rust inhibitors, and anti-wear agents.

### <Base Oil>

The above-explained base oil used is mineral oil, synthetic oil or combination thereof.

The mix ratio (mass ratio) of the mineral oil and the synthetic oil in the base oil is 0:100 to 20:80. When the mix ratio of the synthetic oil is equal to or lower than 80 mass %, it becomes difficult to maintain good torque characteristic and heat resistance. Moreover, the kinematic viscosity of the base oil at the temperature of 40° C. is 70 to 150 mm²/s. Furthermore, the base oil has the fluid point equal to or lower than −40° C.

Specific examples of the above-explained mineral oil are paraffin-based mineral oil and naphthalene-based mineral oil purified by an appropriate combination of pressure-reduction distillation, oil deasphalting, solvent extraction, hydrogenation degradation, solvent deasphalting, vitriol rinsing, white clay purification, and hydrogenation purification.

Moreover, example synthetic oil is hydrocarbon-based oil, aromatic oil, ester-based oil, and ether-based oil. When the base oil according to the present embodiment is hydrocarbon-based oil among the synthetic oils, it is preferable since the torque characteristic is excellent and the matching with a bearing rubber seal (nitrite rubber or fluoric rubber are appropriately used for a wheel supporting rolling bearing unit) is excellent.

A specific example of the hydrocarbon-based oil is poly-α-olefin such as normal-paraffin, iso-paraffin, poly-butene, poly-isobutylene, 1-decene-olygomer, 1-decene, or ethylene-co-olygomer, or a hydrogenated product thereof.

An example of the aromatic oil is alkyl-benzene, such as monoalkyl-benzene, or dialkyl-benzene, or alkyl-naphthalene such as monoalkyl-naphthalene, dialkyl-naphthalene, or polyalkyl-naphthalene.

A specific example of the ester-based oil is diester oil such as dibutyl-sebacate, di-2-ethyl-hexyl-sebacate, dioctyl-adipate, diisodecyl-adipate, ditridecyl-adipate, ditridecyl-glutarate, or methyl-acetyl-sinolate, or aromatic ester oil such as trioctyl-trimellitate, tridecyl-trimellitate, or tetraoctyl-pyromellitate, or furthermore, polyol ester oil such as trimethylol-propane-caprylate, trimethylol-propane-pelargonate, penta-erythritol-2-ethyl-hexanoate, or penta-erythritol-pelargonate, or still further, complex ester oil, etc., that is oligoester of polyalcohol and mixed fatty acid of dibasic acid and monobasic acid.

A specific example of the ether-based oil is polyglycol such as polyethylene glycol, polypropylene glycol, polyethylene glycol monoether, or polypropylene glycol monoether, or phenyl-ether oil such as monoalkyl-triphenyl-ether, alkyl-diphenyl-ether, dialkyl-diphenyl-ether, pentaphenyl-ether, tetraphenyl-ether, monoalkyl-tetraphenyl-ether, or dialkyl-tetraphenyl-ether.

The above-explained mineral oil and synthetic oil can be selected as needed as the base oil, but as explained above, in consideration of the wheel supporting rolling bearing unit being used under a high load and high contact pressure condition, it becomes easy to obtain low torque when a synthetic oil having a low pressure viscosity coefficient and a small high pressure viscosity is used. Accordingly, it is preferable that the mix ratio of the synthetic oil should be high, and is further preferable if the base oil is a 100 percent synthetic oil. In particular, poly-α-olefin of small molecular mass having a branching structure that is alkyl-group with flexibility is preferable. This is because it has such alkyl-group taking various conformations, has a difficulty for a well-ordered arrangement of molecular chains, is not likely to be crystallized and solidified under a high pressure condition, and can maintain a tenacious liquid condition.

### (Kinematic Viscosity)

With respect to the basic oil, it is necessary to select a kinematic viscosity which thickens the oil film thickness as much as possible under a boundary lubrication condition in order to suppress an occurrence of abnormal noises at the time of low-temperature actuation and a seizure under a high temperature and high load condition. When the kinematic viscosity at a temperature of 40° C. is set to be 70 to 150 mm²/s, the occurrence of the above-explained failures can be avoided within a bearing temperature range from −40° C. to 160° C. Moreover, the kinematic viscosity at the temperature of 40° C. set to be 70 to 130 mm²/s is preferable, since a damaging of the raceway surface at the time of low-temperature actuation can be avoided. The kinematic viscosity at the temperature of 40° C. set to be 70 to 100 mm²/s is more preferable, since the increase of torque relative to a normal temperature at the time of low-temperature actuation can be also suppressed.

### (Pour Point)

As explained above, it is presumed that the use temperature of the wheel supporting rolling bearing unit is set, for example, from −40° C. to 160° C., and thus the base oil having the pour point of equal to or lower than −40° C. is utilized. When the pour point of the base oil is equal to or higher than −40° C., a fretting wear at the time of low temperature is weak.

### (Pressure Viscosity Coefficient)

A pressure viscosity coefficient α of the base oil at a temperature of 40° C. calculated through the following So-Klaus estimation formula is set to be equal to or smaller than 33 GPa⁻¹, more preferably, equal to or smaller than 27 GPa⁻¹. When the pressure viscosity coefficient α of the base oil at the temperature of 40° C. exceeds 33 GPa⁻¹, bearing torque increases. More specifically, the pressure viscosity coefficient α of the base oil at the temperature of 40° C. can be calculated through the following So-Klaus estimation formula.

In the following formula, ν₀ is a kinematic viscosity of the base oil at the temperature of 40° C., m₀ is a constant of the Walter's formula (ν₀=(10^{AT})^{-m0}−0.7), and ρ is a density of the base oil at the temperature of 40° C.

α=1.030+3.509(log ν₀)^{3.0627}+2.412×10⁻⁴m₀^{5.1903}(log ν₀)^{1.5976}−3.387(log ν₀)^{3.0975}ρ^{0.1162} (Formula I)

### <Thickener>

A diurea compound can be suitably used as the thickener. For example, aliphatic diurea, alicyclic diurea, or aromatic diurea can be used. Preferably, aromatic diurea is used in consideration of fretting wear caused by vibration originating from vehicle transportation.

More specifically, the thickener is a diurea compound expressed by the following general formula (I) or general formula (II)

### (Aromatic Diurea Compound)

More specifically, the aromatic diurea used as the thickener is a diurea compound expressed by the following general formula (I). In the following general formula (I), R₁ is aromatic-series hydrocarbon group with a carbon number of 6 to 15, R₂ and R₃ are aromatic-series hydrocarbon group with a carbon number of 6 to 12. R₂ and R₃ may be the same or different from each other.

R₂—NHCONH—R₁—NHCONH—R₃ General Formula (I)

As explained above, when the content rate of the diurea compound expressed by the above-explained general formula (I) is less than 10 mass %, it is not preferable since it becomes difficult to maintain a grease condition. Conversely, when the content rate of the diurea compound expressed by the above-explained general formula (I) exceeds 40 mass %, it is not preferable since the grease composition becomes excessively hard, and cannot fully accomplish a lubrication.

### (Aliphatic Diurea, Alicyclic Diurea)

Aliphatic diurea or alicyclic diurea used as the thickener is, more specifically, a diurea compound expressed by the following general formula (II). In the following general formula (II), R₄ is aromatic-series hydrocarbon group with a carbon number of 6 to 15, R₅ and R₆ are aliphatic hydrocarbon group with a carbon number of 6 to 20, and cyclohexyl derivative group with a carbon number of 6 to 12, respectively. The ratio of the cyclohexyl derivative group in the total of R₅ and R₆ is 50 to 90 mol %, and R₅ and R₆ may be the same or different from each other.

When the content rate of the diurea compound expressed by the following general formula (II) is less than 10 mass %, it is not preferable since it becomes difficult to maintain a grease condition. Conversely, when the content rate of the diurea compound expressed by the following general formula (II) exceeds 30 mass %, it is not preferable since the grease composition becomes excessively hard, and cannot fully accomplish a lubrication.

R₅—NHCONH—R₄—NHCONH—R₆ General Formula (II)

With respect to the thickener, the above-explained urea-based thickener is applicable; however in consideration of the wheel supporting rolling bearing unit being used under a high load and high contact pressure condition, it is necessary to select a combination that thickens the oil film thickness as much as possible in a relationship between the raceway surface formed of steel having undergone heat treatment and hardening, such as medium-carbon steel, carburized steel, or bearing steel, balls formed of steel also having undergone heat treatment and hardening, and the base oil.

What is necessary to be especially taken into consideration is the presence/absence of the polarity of the base oil and the thickener.

Both base oil and thickener are so-called organic polymers, but there are polymers of aromatic, etc., having the polarity, and aliphatic or alicyclic polymers, etc., having no polarity.

In general, a lubricant is added with a polarity, and has polar group adsorbed on a metallic (steel) surface to obtain lubrication.

In the case of a grease, however, there is a triangle relationship among the base oil, the thickener, and the metallic surface, when both base oil and thickener have a polarity, for example, respective polar groups of the base oil and the thickener are adsorbed on the metallic surface, and the remaining portions act repulsively, so that there is a disadvantage that the affinity of the base oil and the thickener becomes poor.

Hence, it is preferable that either one of the base oil and the thickener should have a polarity, and the other should have no polarity.

In the case of the grease composition for a wheel supporting rolling bearing unit, it is an application in a high contact pressure and low-rotational speed condition, and a prevention performance of fretting wear (false brinelling) is required at a static condition in which a sufficient oil film formation cannot be expected or no oil film formation is expected at all. Accordingly, it is preferable that the thickener have a polarity and the base oil have no polarity.

Since the thickener in the present embodiment is a diurea compound, i.e., a urea resin, the thickener itself has effects of suppressing a metallic contact and lubricating the metal.

When the diurea compound is one having aromatic-series hydrocarbon group and is let adsorbed on the raceway surface and the balls to suppress a metallic contact (the same effect can be obtained as if the oil film is substantially thickened) and the base oil is a hydrocarbon-based oil with no polarity, e.g., poly-α-olefin, a further suitable grease composition for a wheel supporting rolling bearing unit can be obtained.

### <Rust Inhibitor>

The above-explained rust inhibitor contains three kinds of rust inhibitors that are carboxylic-acid-based rust inhibitor, carboxylate-based rust inhibitor, and amine-based rust inhibitor. When those three kinds of rust inhibitors are combined together, the water resistance (rust proof performance) can be enhanced in comparison with conventional arts, and thus it is suitable as a grease to be packed in a wheel supporting rolling bearing unit which is used under a mud water condition, and which has a high sensitivity against a surface roughness and a hydrogen embrittlement due to rusts originating from a high contact pressure.

The content amount of the rust inhibitor in the total amount of the grease composition is 0.1 to 5 mass % relative to the total amount of the grease composition in the case of the carboxylic-acid based rust inhibitor and the carboxylate-based rust inhibitor. When the added amount is less than 0.1 mass %, a sufficient effect cannot be obtained, and when it exceeds 5%, no improvement of the effect is observed. In consideration of those facts, it is preferable that the added amount should be 0.5 to 3 mass %. The added amount of the amine-based rust inhibitor is 0.1 to 3 mass % relative to the total amount of the grease. When the added amount is less than 0.1 mass %, a sufficient effect cannot be obtained, and when it exceeds 3%, no improvement of the effect is observed and the adsorption amount to the surface of the bearing member becomes excessive, so that a production of an oxidized film, etc., originating from the packed grease may be inhibited.

### (Carboxylic-Acid-Based Rust Inhibitor)

An example carboxylic-acid-based rust inhibitor is, in the case of monocarboxylic acid, straight-chain aliphatic acid such as lauric acid or stearic acid, and saturated carboxylic acid having napththene nucleus. Moreover, in the case of dicarboxylic acid, succinic acid derivative such as succinic acid, alkyl-succinic acid, alkyl-succinic-acid-half-ester, alkenyl-succinic acid, alkenyl-succinic-acid-half-ester, or succenic-acid-imide, hydroxy-aliphatic acid, mercapto-aliphatic acid, sarcosine derivative, and oxidized wax like oxide of wax and petrolatum. In particular, succinic-acid-half-ester is suitable.

### (Carboxylate-Based Rust Inhibitor)

Example carboxylate-based rust inhibitors are various metallic salts of amino acid derivative such as aliphatic acid, naphthene acid, abietic acid, lanolin aliphatic acid, or alkenyl-succinic acid. An example metallic element of the metallic salt is cobalt, manganese, zinc, aluminum, calcium, barium, lithium, magnesium, or copper. In particular, napthene acid zinc is suitable.

### (Amine-Based Rust Inhibitor)

An example amine-based rust inhibitor is alkoxy-phenyl-amine, amine salt of aliphatic acid, or partial amide of dibasic carboxylic acid. In particular, amine salt of aliphatic acid is suitable.

### (Anti-Wear Agent)

An example anti-wear agent applied is sulfur-phosphorous-based (SP-based) compound. An example sulfur-phosphorous-based (SP-based) compound is triphenyl-phosphate-based compound and dithio-phosphate-based compound. In the present embodiment, triphenyl-phosphorothioate (TPPT) expressed by the following general formula (III) is suitable.

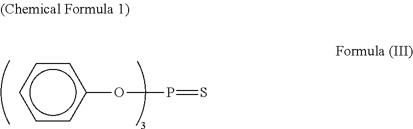

It is preferable that the content amount of the above-explained anti-wear agent should be 0.1 to 5 mass % relative to the total amount of the grease composition. When the content amount is less than 0.1 mass %, a sufficient effect cannot be obtained, and when it exceeds 5%, no improvement of the effect is observed.

### <Other Additives>

Other additives may be added to the grease composition of this embodiment in order to further enhance various performances as needed. For example, antioxidizing agent, extreme-pressure additive, oiliness improver, and metal deactivator, etc., may be added in solo or in combination of equal to or greater than two kinds thereof.

The content amount (added amount) of those other additives is not limited to any particular one as long as the effect of the present invention is not deteriorated, but in general, is 0.1 to 20 mass % relative to the total amount of the grease composition. When the added amount is less than 0.1 mass %, an additive effect becomes insufficient. However, even when it exceeds 20 mass %, added additives cause a saturation of the effect, and decrease the relative amount of the base oil, and thus the lubricity may decrease.

### (Antioxidizing Agent)

An example antioxidizing agent is amine-based antioxidizing agent, phenol-based antioxidizing agent, sulfur-based antioxidizing agent, or zinc dithiophosphate.

A specific example of amine-based antioxidizing agent is phenyl-1-naphthylamine, phenyl-2-naphtylamine, diphenyl-amine, phenylene-diamine, oleyl-amide-amine, or phenothiazine.

A specific example of the phenol-based antioxidizing agent is hindered phenol, etc., such as
p-t-butyl-phenyl-salicylate,
2,6-di-t-butyl-p-phenyl-phenol,
2,2′-methylen-bis(4-methyl-6-t-octyle-phenol),
4,4′-butylidene-bis-6-t-butyl-m-cresol,
tetrakis[methylene-3-(3′,5′-di-butyl-4′-hydroxyphenyl)propionate]methane,
1,3,5-trimethyl-2,4,6-tris(3,5-di-t-butyl-4-hydroxybenzil)benzene,
n-octadecyl-β-(4′-hydroxy-3′,5′-di-t-butylphenyl)propionate,
2-n-octyl-thio-4,6-di(4′-hydroxy-3′,5′-di-t-butyl)phenoxy-1,3,5-triazine, 4,4′-thiobis(6-t-butyl-m-cresol), or
2-(2′-hydroxy-3′-t-butyl-5′-methylphenyl)-5-chlorobenzotriazole.

### (Extreme-Pressure Additive)

An example extreme-pressure additive is organic molybdenum.

### (Oiliness Improver)

An example oiliness improver is aliphatic acid such as oleic acid or stearic acid, alcohol such as lauryl alcohol or oleyl alcohol, amine such as stearyl amine or cetyl amine, ester phosphate such as tricresyl phosphate, or oil extracted from animals and plants.

### (Metal Deactivator)

An example metal deactivator is benzo-triazole.

### <Method of Producing Grease Composition>

A method of producing the grease composition containing the above-explained respective constituents according to the present embodiment is not limited to any particular one, and is selected as needed depending on a purpose. In general, however, the raw materials of the thickener (aromatic-series diurea compound, or aliphatic diurea and alicyclic diurea) is reacted in the above-explained base oil, a fixed quantity of the above-explained rust inhibitor and that of the above-explained anti-wear agent are added, and the mixture is sufficiently stirred with a kneader or roll mill, etc., to uniformly disperse it, thereby obtaining a target grease composition. In this process, heating is also effective. When another additive is added, it is preferable to add it simultaneously with the above-explained rust inhibitor in light of the process.

### EXAMPLES

The present invention will be further explained below with reference to examples and comparative examples based on the grease composition according to the above-explained embodiment, but the present invention is not limited to the following explanation.

### Examples 1 to 17 and Comparative Examples 1 to 13

Grease composition with composition indicated in tables 1 and 4 were prepared, and for each grease composition, screening tests that were (1) bearing torque test, (2) friction test, (3) fast-speed four-ball test (wear resistance test), (4) fretting resistance test, (5) rolling four-ball test (water resistance test), (6) bearing leakage test, (7) low-temperature fretting test, and (8) high-temperature protracted test explained below were carried out. The summary of each test will be explained below and each test result of (1) to (8) is indicated in tables 1 to 4.

In the field of “base oil” in tables 1 to 4, “mineral oil A” is mineral oil having a kinematic viscosity of 30 mm²/s at a temperature of 40° C. Moreover, “mineral oil B” is mineral oil having a kinematic viscosity of 70 mm²/s at a temperature of 40° C. “Mineral oil C” is mineral oil having a kinematic viscosity of 75 mm²/s at a temperature of 40° C. “Mineral oil D” is mineral oil having a kinematic viscosity of 100 mm²/s at a temperature of 40° C. “mineral oil E” is mineral oil having a kinematic viscosity of 130 mm²/s at a temperature of 40° C. Furthermore, “mineral oil F” is mineral oil having a kinematic viscosity of 150 mm²/s at a temperature of 40° C.

In the field of “base oil” in tables 1 to 4, “poly-α-olefin oil G” is synthetic oil having a kinematic viscosity of 30 mm²/s at a temperature of 40° C. Moreover, “poly-α-olefin oil H” is synthetic oil having a kinematic viscosity of 70 mm²/s at a temperature of 40° C.

“Poly-α-olefin oil I” is synthetic oil having a kinematic viscosity of 75 mm²/s at a temperature of 40° C.

“Poly-α-olefin oil J” is synthetic oil having a kinematic viscosity of 100 mm²/s at a temperature of 40° C.

“Poly-α-olefin oil K” is synthetic oil having a kinematic viscosity of 130 mm²/s at a temperature of 40° C.

“Poly-α-olefin oil L” is synthetic oil having a kinematic viscosity of 150 mm²/s at a temperature of 40° C. Furthermore,

“poly-α-olefin oil M” is synthetic oil having a kinematic viscosity of 160 mm²/s at a temperature of 40° C.

Moreover, in the field of “base oil” in tables 1 to 4, “ester oil N” is synthetic oil having a kinematic viscosity of 75 mm²/s at a temperature of 40° C. Moreover, “ether oil O” is synthetic oil having a kinematic viscosity of 75 mm²/s at a temperature of 40° C.

In the field of “thickener” in tables 1 to 4, “aromatic diurea” is a diurea compound produced by a reaction of 4,4′-diphenyl-methane-di-isocyanate and p-toluidine. Moreover, “alicyclic diurea” is a diurea compound produced by a reaction of 4,4′-diphenyl-methane-di-isocyanate and cyclohexylamine. Furthermore, “aliphatic diurea” is a diurea compound produced by a reaction of 4,4′-diphenyl-methane-di-isocyanate and stearylamine.

The penetration of each grease composition in tables 1 to 4 was adjusted to NLGL (National Lubricating Grease Institute) No. 2.

### (1) Bearing Torque Test

The respective grease compositions indicated in tables 1 to 4 were packed in single row deep groove ball bearings with a non-contact seal (bore diameter: 17 mm, outside diameter: 40 mm, and width: 12 mm), and sample bearings were prepared. Next, the sample bearings were rotated for 600 seconds at a rotational speed of 450 min⁻¹, an axial load of 392 N, and a radial load of 29.4 N, and then running torques were measured. An evaluation standard is a relative torque value with respect to a comparison example 1, and a grease composition packed in a sample bearing having a relative torque value of less than 1.0 was determined*as success in the test. Evaluation results are indicated in tables 1 to 4.

As indicated in tables 3 and 4, the sample bearings of comparative examples 1, 3 to 6, and 8 to 13 were equal to or greater than 1.0, whereas as indicated in tables 1 and 2, sample bearings of examples 1 to 17 had all relative torque value of less than 1.0, and satisfied the success result standard.

Moreover, it becomes clear that the grease composition using the base oil having a pressure viscosity coefficient α of equal to or less than 33 GPa⁻¹ at a temperature of 40° C. had an excellent torque characteristic. Furthermore, the grease composition using the base oil having a pressure viscosity coefficient α of equal to or less than 27 GPa⁻¹ at a temperature of 40° C. had a remarkably excellent torque characteristic.

### (2) Friction Test

Sliding friction coefficients of the respective grease compositions were measured through a ball-on-disk tester. As test pieces, a ball of ⅜ inch and a disk of SUJ2 having undergone mirror finishing were used. As a test condition, each grease composition was applied to the disk at a thickness of 0.5 mm, a vertical load was set to be 500 g, a sliding speed was set to be 1 m/s, and an average of the friction coefficients during one second that was from one second after the test started to two seconds after the start of the test was taken as the friction coefficient of each grease composition. The evaluation standard was a relative friction coefficient to the comparative example 1, and the grease composition having this relative friction coefficient of less than 1.0 was determined as success in the test. Evaluation results are indicated in tables 1 to 4.

As indicated in tables 3 and 4, the respective grease compositions of the comparative examples 1, 3 to 6, and 8 to 13 had all the relative friction coefficient that was equal to or greater than 1.0, whereas as indicated in tables 1 and 2, the respective grease compositions of the examples 1 to 17 had all the relative friction coefficient of less than 1.0, and satisfied the success standard.

### (3) Fast-Speed Four-Ball Test (Wear Resistance Test)

The wear resistance of each grease composition was evaluated through a fast-speed four-ball tester defined in ASTM D2596. That is, three fixed balls were fixed in an equilateral triangular shape in a test cup filled with each grease composition, one rotating ball attached to a rotation shaft was placed in a cavity defined by the three steel balls, and was rotated for 10 seconds at 1770 min⁻¹ while a certain load was being applied, and a wear mark formed on the fixed balls at that time was measured. Next, a load (last non-seizure load) when an average diameter of the wear mark became smaller than the compensation wear mark diameter value defined in ASTM D2596 was obtained. Moreover, the rolling ball was likewise rotated, and a load (weld point) when a welding was caused was obtained.

The wear resistance was evaluated through LNSL (L. N. S. L: Last Non-seizure Load) and WP (W. P.: Weld Point), and it was determined as success in test (Good) when the last non-seizure load was equal to or greater than 490 N and the weld point was equal to or greater than 1236 N. Evaluation results were indicated in tables 1 to 4.

### (4) Fretting Resistance Test

For each grease composition, a fretting resistance test was carried out through a test method technique defined in ASTM D4170, a difference in mass before and after the test was measured, and was classified into the following three ranks. It is regarded that Rank A and Rank B are suitable for automobiles, and Rank A and Rank B were also taken as success results in this test. Evaluation results are indicated in tables 1 to 4.

Rank A: mass reduction is equal to or smaller than 3 mg;

Rank B: mass reduction exceeds 3 mg but is less than 5 mg; and

Rank C: mass reduction is equal to or greater than 5 mg.

### (5) Rolling Four-Ball Test (Water Resistance Test)

The water resistance of each grease composition was evaluated through a rolling four-ball test. That is, three bearing steel balls having a diameter of 15 mm was prepared, was placed in an equilateral triangular shape in a conical cup having an internal diameter of a bottom face that was 36.0 mm, an internal diameter of the upper end that was 31.63 mm, and a depth of 10.98 mm. Each grease composition mixed with water by 20% was applied by 20 g, and a bearing steel ball with a diameter of ⅝ inch was further placed in a cavity defined by the three steel balls. Such a bearing steel ball with a diameter of ⅝ inch was rotated at 1000 min⁻¹ at a room temperature while a load that was a surface pressure of 4.1 GPa was being applied. Accordingly, the three bearing steel balls with a diameter of 15 mm also revolved while being rotated, but were continuously rotated until a spall was caused. A total number of rotations when a spall was caused was taken as the lifetime. Evaluation results are indicated in tables 1 to 4.

### (6) Bearing Leakage Test

Each grease composition was packed in a single row deep groove ball bearing (bore diameter: 25 mm, outside diameter: 62 mm, and width: 17 mm) with a non-contact seal, the bearing was continuously rotated for 20 hours at an outer ring temperature of 80° C., an axial load of 98 N, a radial load of 98 N, and a rotational speed of 5000 min⁻¹. The leakage percentage (bearing leakage test) of the grease composition was measured based on a difference in mass of the grease composition before and after the rotation. Evaluation results are indicated in tables 1 to 4. Regarding the evaluation of the bearing leakage test, with a result of bearing leakage test (leakage percentage of grease composition) of the grease composition of the comparative example 1 employing the composition indicated in tables 3 and 4 being 1, when the relative leakage percentage was equal to or smaller than 2.0, it was determined as success, and when the relative leakage percentage was greater than 2.0, it was determined as failure.

### (7) Low-Temperature Fretting Test

A low-temperature fretting test was carried out for each grease composition through an SNR-FEB2 test (load: 8000 N, hours: five hours, swing angle: 6 degrees, swing cycle: 24 Hz, and temperature: −20° C.) to measure a difference in mass before and after the test, and such differences were classified into the following three ranks. Rank A and Rank B are regarded as suitable for automobiles, and Rank A and Rank B were taken as success results in this test. Evaluation results are indicated in tables 1 to 4.

Rank A: mass reduction is equal to or smaller than 20 mg;

Rank B: mass reduction exceeds 20 mg but is less than 50 mg; and

Rank C: mass reduction is equal to or greater than 50 mg.

### (8) High-Temperature Protracted Test (Thermal Stability Test)

Each grease composition was applied to a metal plate at a thickness of 2 mm, and left for 200 hours in a constant temperature chamber of 150° C. Thereafter, total acid number was measured through potassium hydroxide, and a difference from the total acid number of the equivalent grease composition not left at the constant temperature was calculated. This value indicates a larger value as the oxidization of the grease further advances, and it can be determined that the deterioration is advanced. One having the total acid number decreased (negative value) was determined as a success result in the examples. Evaluation results are indicated in tables 1 to 4.

TABLE 1

| | | EXAM- | EXAM- | EXAM- | EXAM- | EXAM- | EXAM- | EXAM- | EXAM- |
|---|---|---|---|---|---|---|---|---|---|
| | | PLE 1 | PLE 2 | PLE 3 | PLE 4 | PLE 5 | PLE 6 | PLE 7 | PLE 8 |
| BASE OIL | MINERAL OIL A | — | — | — | — | — | — | — | — |
| | MINERAL OIL B | — | — | — | — | — | — | — | 20 |
| | MINERAL OIL C | — | — | — | 20 | — | — | — | — |
| | MINERAL OIL D | — | — | — | — | — | — | — | — |
| | MINERAL OIL E | — | — | — | — | — | — | — | — |
| | MINERAL OIL F | — | — | — | — | — | — | — | — |
| | POLY-α-OLEFIN OIL G | — | — | — | — | — | — | — | — |
| | POLY-α-OLEFIN OIL H | — | — | — | — | — | — | — | 80 |
| | POLY-α-OLEFIN OIL I | 100 | — | — | 80 | 100 | — | — | — |
| | POLY-α-OLEFIN OIL J | — | 100 | — | — | — | — | — | — |
| | POLY-α-OLEFIN OIL K | — | — | 100 | — | — | — | — | — |
| | POLY-α-OLEFIN OIL L | — | — | — | — | — | — | — | — |
| | POLY-α-OLEFIN OIL M | — | — | — | — | — | — | — | — |
| | ESTER OIL N | — | — | — | — | — | 100 | — | — |
| | ETHER OIL O | — | — | — | — | — | — | 100 | — |
| THICKENER | AROMATIC-SERIES | 18 | 18 | 18 | 18 | 30 | 18 | 18 | 18 |
| | DIUREA | | | | | | | | |
| | ALICYCLIC DIUREA | — | — | — | — | — | — | — | — |
| | ALIPHATIC DIUREA | — | — | — | — | — | — | — | — |
| ANTIOXIDIZING | p,p′-DIOCTYL- | 1 | 1 | 1 | 1 | 1 | 1 | 1 | 1 |
| AGENT | DIPHENYL-AMINE | | | | | | | | |
| RUST | SUCCINIC-ACID | 1 | 1 | 1 | 1 | 1 | 1 | 1 | 1 |
| INHIBITOR | HALF ESTER | | | | | | | | |
| | ZINC NAPHTHENATE | 1 | 1 | 1 | 1 | 1 | 1 | 1 | 1 |
| | AMINE SALT OF | 1 | 1 | 1 | 1 | 1 | 1 | 1 | 1 |
| | ALIPHATIC ACID | | | | | | | | |
| | BARIUM SULFONATE | — | — | — | — | — | — | — | — |
| ANTI-WEAR | TRIPHENYL- | 0.5 | 1 | 1 | 1 | 1 | 1 | 1 | 1 |
| AGENT | PHOSPHOROTHIOATE | | | | | | | | |
| BASE OIL KINEMATIC VISCOSITY | | 75 | 100 | 130 | 75 | 75 | 75 | 75 | 70 |
| (40° C., mm²/s) | | | | | | | | | |
| BASE OIL POUR POINT (° C.) | | −55 | −52 | −50 | −45 | −55 | −43 | −42 | −57 |
| PRESSURE VISCOSITY | | 27 | 29 | 31 | 27 | 27 | 23 | 26 | 27 |
| COEFFICIENT | | | | | | | | | |
| BEARING TORQUE RATIO | | 0.5 | 0.7 | 0.9 | 0.6 | 0.6 | 0.9 | 0.8 | 0.6 |
| FOUR-BALL | LAST NON-SEIZURE | Good | Good | Good | Good | Good | Good | Good | Good |
| TEST AT FAST | LOAD (L.N.S.L) | | | | | | | | |
| SPEED | WELD POINT (W.P.) | Good | Good | Good | Good | Good | Good | Good | Good |

| | | | | | | | | |
|---|---|---|---|---|---|---|---|---|
| INCREASE AMOUNT OF TOTAL ACID | −2.7 | −2.7 | −2.7 | −2.5 | −2.7 | −2.6 | −2.6 | −2.5 |
| NUMBER AFTER LEFT AT HIGH | | | | | | | | |
| TEMPERATURE (mgKOH/g) | | | | | | | | |
| FRETTING RESISTANCE TEST | A | A | B | B | A | B | B | A |
| LOW-TEMPERATURE FRETTING | A | A | A | A | A | B | B | A |
| ROLLING FOUR-BALL TEST | 1650 | 1750 | 1800 | 1500 | 1600 | 1450 | 1450 | 1600 |
| (×1000, ROTATION) | | | | | | | | |
| FRICTION TEST | 0.7 | 0.7 | 0.8 | 0.8 | 0.8 | 0.9 | 0.8 | 0.8 |
| (BALL-ON DISK, 1 m/s) | | | | | | | | |
| BEARING LEAKAGE TEST | 1.0 | 1.0 | 0.9 | 1.0 | 0.5 | 0.9 | 1.0 | 1.1 |

TABLE 2

| | | | EXAM- | EXAM- | EXAM- | EXAM- | EXAM- | EXAM- | EXAM- | EXAM- |
|---|---|---|---|---|---|---|---|---|---|---|
| | | EXAM- | PLE | PLE | PLE | PLE | PLE | PLE | PLE | PLE |
| | | PLE 9 | 10 | 11 | 12 | 13 | 14 | 15 | 16 | 17 |
| BASE OIL | MINERAL OIL A | — | — | — | — | — | — | — | — | — |
| | MINERAL OIL B | — | — | — | — | — | — | — | — | — |
| | MINERAL OIL C | — | 20 | 20 | — | — | 20 | 20 | — | — |
| | MINERAL OIL D | — | — | — | — | — | — | — | — | — |
| | MINERAL OIL E | — | — | — | 20 | — | — | — | — | — |
| | MINERAL OIL F | 20 | — | — | — | — | — | — | — | — |
| | POLY-α-OLEFIN OIL G | — | — | — | — | — | — | — | — | — |
| | POLY-α-OLEFIN OIL H | — | — | — | — | — | — | — | — | — |
| | POLY-α-OLEFIN OIL I | — | 80 | 80 | — | 100 | 80 | 80 | 100 | — |
| | POLY-α-OLEFIN OIL J | — | — | — | — | — | — | — | — | — |
| | POLY-α-OLEFIN OIL K | — | — | — | 80 | — | — | — | — | — |
| | POLY-α-OLEFIN OIL L | 80 | — | — | — | — | — | — | — | — |
| | POLY-α-OLEFIN OIL M | — | — | — | — | — | — | — | — | — |
| | ESTER OIL N | — | — | — | — | — | — | — | — | — |
| | ETHER OIL O | — | — | — | — | — | — | — | — | 100 |
| THICKENER | AROMATIC-SERIES | 18 | 18 | 40 | 18 | 10 | 18 | 18 | 18 | 18 |
| | DIUREA | | | | | | | | | |
| | ALICYCLIC DIUREA | — | — | — | — | — | — | — | — | — |
| | ALIPHATIC DIUREA | — | — | — | — | — | — | — | — | — |
| ANTIOXIDIZING | p,p′-DIOCTYL- | 1 | 1 | 1 | 1 | 1 | 1 | 1 | 1 | 1 |
| AGENT | DIPHENYL-AMINE | | | | | | | | | |
| RUST | SUCCINIC-ACID | 1 | 1 | 1 | 1 | 1 | 0.8 | 0.5 | 0.5 | 0.5 |
| INHIBITOR | HALF ESTER | | | | | | | | | |
| | ZINC NAPHTHENATE | 1 | 1 | 1 | 1 | 1 | 0.8 | 0.5 | 0.5 | 0.5 |
| | AMINE SALT OF | 1 | 1 | 1 | 1 | 1 | 0.8 | 2.0 | 2.0 | — |
| | ALIPHATIC ACID | | | | | | | | | |
| | BARIUM SULFONATE | — | — | — | — | — | — | — | — | — |
| ANTI-WEAR | TRIPHENYL- | 1 | 1 | 1 | 1 | 1 | 1 | 1 | 1 | 1 |
| AGENT | PHOSPHOROTHIOATE | | | | | | | | | |
| BASE OIL KINEMATIC VISCOSITY | | 150 | 75 | 75 | 130 | 75 | 75 | 75 | 75 | 75 |
| (40° C., mm²/s) | | | | | | | | | | |
| BASE OIL POUR POINT (° C.) | | −50 | −55 | −55 | −40 | −55 | −45 | −45 | −55 | −42 |
| PRESSURE VISCOSITY | | 33 | 27 | 27 | 31 | 27 | 27 | 27 | 27 | 28 |
| COEFFICIENT (40° C.) | | | | | | | | | | |
| BEARING TORQUE RATIO | | 0.4 | 0.6 | 0.9 | 0.9 | 0.6 | 0.8 | 0.8 | 0.5 | 0.8 |
| FOUR-BALL | LAST NON-SEIZURE | Good | Good | Good | Good | Good | Good | Good | Good | Good |
| TEST AT FAST | LOAD (L.N.S.L) | | | | | | | | | |
| SPEED | WELD POINT (W.P.) | Good | Good | Good | Good | Good | Good | Good | Good | Good |

| | | | | | | | | | |
|---|---|---|---|---|---|---|---|---|---|
| INCREASE AMOUNT OF TOTAL ACID | −2.5 | −2.5 | −2.5 | −2.5 | −2.7 | −2.2 | −2.7 | −2.7 | 1.1 |
| NUMBER AFTER LEFT AT HIGH | | | | | | | | | |
| TEMPERATURE (mgKOH/g) | | | | | | | | | |
| FRETTING RESISTANCE TEST | A | A | B | B | A | A | A | A | B |
| LOW-TEMPERATURE FRETTING | A | A | A | B | A | B | B | A | B |
| ROLLING FOUR-BALL TEST | 1800 | 1650 | 1450 | 1500 | 1650 | 1500 | 1500 | 1600 | 1450 |
| (×1000, ROTATION) | | | | | | | | | |
| FRICTION TEST | 0.9 | 0.8 | 0.8 | 0.9 | 0.7 | 0.8 | 0.8 | 0.7 | 0.8 |
| (BALL-ON DISK, 1 m/s) | | | | | | | | | |
| BEARING LEAKAGE TEST | 1.0 | 1.0 | 0.3 | 0.9 | 2.0 | 1.8 | 1.0 | 1.0 | 1.0 |

TABLE 3

| | | COM- | COM- | COM- | COM- | COM- | COM- |
|---|---|---|---|---|---|---|---|
| | | PARATIVE | PARATIVE | PARATIVE | PARATIVE | PARATIVE | PARATIVE |
| | | EXAMPLE 1 | EXAMPLE 2 | EXAMPLE 3 | EXAMPLE 4 | EXAMPLE 5 | EXAMPLE 6 |
| BASE OIL | MINERAL OIL A | — | 100 | — | — | — | — |
| | MINERAL OIL B | — | — | 100 | — | — | — |
| | MINERAL OIL C | 100 | — | — | — | — | — |
| | MINERAL OIL D | — | — | — | — | — | 80 |
| | MINERAL OIL E | — | — | — | 100 | — | — |
| | MINERAL OIL F | — | — | — | — | — | — |
| | POLY-α-OLEFIN OIL G | — | — | — | — | — | — |
| | POLY-α-OLEFIN OIL H | — | — | — | — | — | — |
| | POLY-α-OLEFIN OIL I | — | — | — | — | — | — |
| | POLY-α-OLEFIN OIL J | — | — | — | — | — | 20 |
| | POLY-α-OLEFIN OIL K | — | — | — | — | — | — |
| | POLY-α-OLEFIN OIL L | — | — | — | — | — | — |
| | POLY-α-OLEFIN OIL M | — | — | — | — | 100 | — |
| | ESTER OIL N | — | — | — | — | — | — |
| | ETHER OIL O | — | — | — | — | — | — |
| THICKENER | AROMATIC-SERIES | 18 | 18 | 18 | 18 | 18 | 18 |
| | DIUREA | | | | | | |
| | ALICYCLIC DIUREA | — | — | — | — | — | — |
| | ALIPHATIC DIUREA | — | — | — | — | — | — |
| ANTIOXIDIZING | p,p′-DIOCTYL- | — | — | — | — | 1 | 1 |
| AGENT | DIPHENYL-AMINE | | | | | | |
| RUST | SUCCINIC-ACID | — | — | — | — | 1 | 1 |
| INHIBITOR | HALF ESTER | | | | | | |
| | ZINC NAPHTHENATE | — | — | — | — | 1 | 1 |
| | AMINE SALT OF | — | — | — | — | 1 | 1 |
| | ALIPHATIC ACID | | | | | | |
| | BARIUM SULFONATE | — | 1 | 1 | 1 | — | — |
| ANTI-WEAR | TRIPHENYL- | — | — | 1 | — | — | 1 |
| AGENT | PHOSPHOROTHIOATE | | | | | | |
| BASE OIL KINEMATIC VISCOSITY | | 100 | 30 | 75 | 130 | 160 | 100 |
| (40° C., mm²/s) | | | | | | | |
| BASE OIL POUR POINT (° C.) | | −10 | −10 | −10 | −10 | −45 | −35 |
| PRESSURE VISCOSITY | | 29 | 22 | 29 | 34 | 33 | 31 |
| COEFFICIENT (40° C.) | | | | | | | |
| BEARING TORQUE RATIO | | 1 | 0.8 | 1 | 1 | 1.1 | 1 |
| FOUR-BALL | LAST NON-SEIZURE | NG | NG | NG | NG | NG | Good |
| TEST AT FAST | LOAD (L.N.S.L) | | | | | | |
| SPEED | WELD POINT (W.P.) | NG | NG | Good | NG | Good | Good |

| | | | | | | |
|---|---|---|---|---|---|---|
| INCREASE AMOUNT OF TOTAL ACID | 1.9 | 1.9 | 1.9 | 1.9 | −2.7 | −2.3 |
| NUMBER AFTER LEFT AT HIGH | | | | | | |
| TEMPERATURE (mgKOH/g) | | | | | | |
| FRETTING RESISTANCE TEST | C | B | C | C | B | C |
| LOW-TEMPERATURE FRETTING | C | C | C | C | B | B |
| ROLLING FOUR-BALL TEST | 450 | 150 | 650 | 800 | 1500 | 1300 |
| (×1000, ROTATION) | | | | | | |
| FRICTION TEST | 1 | 0.9 | 1 | 1 | 1.1 | 1 |
| (BALL-ON DISK, 1 m/s) | | | | | | |
| BEARING LEAKAGE TEST | 1.0 | 1.1 | 1.0 | 1.0 | 0.9 | 1.0 |

TABLE 4

| | | | | | | |
|---|---|---|---|---|---|---|
| COM- | COM- | COM- | COM- | COM- | COM- | COM- |
| PARATIVE | PARATIVE | PARATIVE | PARATIVE | PARATIVE | PARATIVE | PARATIVE |
| EXAM- | EXAM- | EXAM- | EXAM- | EXAM- | EXAM- | EXAM- |
| PLE 7 | PLE 8 | PLE 9 | PLE 10 | PLE 11 | PLE 12 | PLE 13 |

| | | | | | | | | |
|---|---|---|---|---|---|---|---|---|
| BASE OIL | MINERAL OIL A | — | — | — | — | — | — | — |
| | MINERAL OIL B | — | — | — | — | — | — | — |
| | MINERAL OIL C | — | — | — | — | 80 | 80 | 100 |
| | MINERAL OIL D | — | — | — | — | — | — | — |
| | MINERAL OIL E | — | — | — | — | — | — | — |
| | MINERAL OIL F | — | — | — | — | — | — | — |
| | POLY-α-OLEFIN OIL G | 100 | — | — | — | — | — | — |
| | POLY-α-OLEFIN OIL H | — | — | — | — | — | — | — |
| | POLY-α-OLEFIN OIL I | — | 100 | 100 | — | 20 | 20 | — |
| | POLY-α-OLEFIN OIL J | — | — | — | — | — | — | — |
| | POLY-α-OLEFIN OIL K | — | — | — | 100 | — | — | — |
| | POLY-α-OLEFIN OIL L | — | — | — | — | — | — | — |
| | POLY-α-OLEFIN OIL M | — | — | — | — | — | — | |
| | ESTER OIL N | — | — | — | — | — | — | — |
| | ETHER OIL O | — | — | — | — | — | — | — |
| THICKENER | AROMATIC-SERIES | 18 | — | 45 | — | 18 | 7 | 18 |
| | DIUREA | | | | | | | |
| | ALICYCLIC DIUREA | — | — | — | 4 | — | — | — |
| | ALIPHATIC DIUREA | — | 30 | — | 15 | — | — | — |
| ANTIOXIDIZING | p,p′-DIOCTYL- | 1 | 1 | 1 | — | 1 | 1 | 1 |
| AGENT | DIPHENYL-AMINE | | | | | | | |
| RUST | SUCCINIC-ACID | 1 | 1 | 1 | — | 0.2 | 5 | 0.5 |
| INHIBITOR | HALF ESTER | | | | | | | |
| | ZINC NAPHTHENATE | 1 | 1 | 1 | — | 0.2 | 5 | 0.5 |
| | AMINE SALT OF | 1 | 1 | 1 | — | 0.2 | 5 | 2 |
| | ALIPHATIC ACID | | | | | | | |
| | BARIUM SULFONATE | — | — | — | — | — | — | — |
| ANTI-WEAR | TRIPHENYL- | 1 | 1 | 1 | — | 1 | 1 | 1 |
| AGENT | PHOSPHOROTHIOATE | | | | | | | |

| BASE OIL KINEMATIC VISCOSITY | | 30 | 75 | 75 | 130 | 75 | 75 | 100 |
|---|---|---|---|---|---|---|---|---|
| (40° C., mm²/s) | | | | | | | | |
| BASE OIL POUR POINT (° C.) | | −70 | −50 | −50 | −50 | −35 | −35 | −10 |
| PRESSURE VISCOSITY | | 21 | 27 | 27 | 31 | 27 | 27 | 29 |
| COEFFICIENT (40° C.) | | | | | | | | |
| BEARING TORQUE RATIO | | 0.7 | 1.3 | 1.1 | 1 | 1 | 1.1 | 1 |
| FOUR-BALL | LAST NON-SEIZURE | NG | NG | NG | NG | Good | Good | Good |
| TEST AT FAST | LOAD (L.N.S.L) | | | | | | | |
| SPEED | WELD POINT (W.P.) | NG | NG | NG | NG | Good | Good | Good |

| | | | | | | | |
|---|---|---|---|---|---|---|---|
| INCREASE AMOUNT OF TOTAL ACID | −2.7 | −2.7 | −2.7 | −2.7 | 0.6 | −2.2 | −2.3 |
| NUMBER AFTER LEFT AT HIGH | | | | | | | |
| TEMPERATURE (mgKOH/g) | | | | | | | |
| FRETTING RESISTANCE TEST | A | C | B | C | C | C | A |
| LOW-TEMPERATURE FRETTING | A | C | C | C | B | B | B |
| ROLLING FOUR-BALL TEST | 750 | 100 | 300 | 1000 | 600 | 1400 | 1300 |
| (×1000, ROTATION) | | | | | | | |
| FRICTION TEST | 0.7 | 1.3 | 1.2 | 1 | 1 | 1.1 | 1 |
| (BALL-ON DISK, 1 m/s) | | | | | | | |
| BEARING LEAKAGE TEST | 1.0 | 0.4 | 0.2 | 0.7 | 1.0 | 2.0 | 1.0 |

As indicated in tables 1 and 2, the grease composition containing the base oil which has a pour point of equal to or lower than −40° C., a kinematic viscosity of 70 to 130 mm²/s, and a mix ratio (mass %) of 0:100 to 20:80 between the mineral oil and the synthetic oil, and a thickener which is an aromatic-series diurea compound and which has a content amount of 10 to 40 mass % has excellent low-temperature fretting characteristic, low-torque characteristic, and low leakage performance when packed in a bearing. Conversely, as indicated in tables 3 and 4, the grease composition having the base oil not satisfying the above-explained condition or has the content amount of the thickener not satisfying the above-explained condition has a poor lubrication performance, and thus any of the torque characteristic, the wear resistance, the anti-seizing performance, and the low leakage performance when packed in a bearing was poor as a result.

Moreover, as indicated in tables 1 and 2, the grease composition containing three kinds of the carboxylic-acid-based rust inhibitor additive, the carboxylate-based rust inhibitor additive and the amine-based rust inhibitor, and, the anti-wear agent has excellent spall resistance, anti-wear performance, fretting resistant performance, and corrosion resistance. Conversely, as indicated in tables 3 and 4, the grease composition which does not contain the three kinds of the carboxylic-acid-based rust inhibitor additive, the carboxylate-based rust inhibitor additive and the amine-based rust inhibitor, but which contains barium-sulfonate as a rust inhibitor cannot obtain sufficient spall resistance and corrosion resistance. In particular, it becomes clear that the carboxylic-acid-based rust inhibitor additive, the carboxylate-based rust inhibitor additive, and the amine-based rust inhibitor have a function of suppressing an increase of a total acid number. Based on the results indicated in tables 1 to 4, as illustrated in FIG. 5, when it is attempted to clarify a relationship between the content amount of the rust inhibitors and the increase amount of the total acid number, it becomes clear that the necessary content rate (mass %) of the rust inhibitors is equal to or greater than 1 mass % relative to the total amount of the grease composition in order to provide a grease composition that decreases the total acid number, i.e., a grease composition with a high thermal stability. Moreover, it becomes also clear that the grease composition having no anti-wear agent contained therein cannot obtain a sufficient anti-wear performance. Furthermore, it becomes clear that the grease composition having the aliphatic urea compound applied as a thickener has a poor fretting resistant performance.

The embodiments of the present invention have been explained above, but the present invention is not limited to the above explanation, and various modifications and improvements are applicable.

### (Wheel Supporting Rolling Bearing Unit)

An explanation will be below given of an embodiment of a wheel supporting rolling bearing unit. In the explanation of the present embodiment, the explanation will be given of an example wheel supporting rolling bearing unit to which the grease composition of the above-explained embodiment is applicable and an example axle structure using this wheel supporting rolling bearing unit.

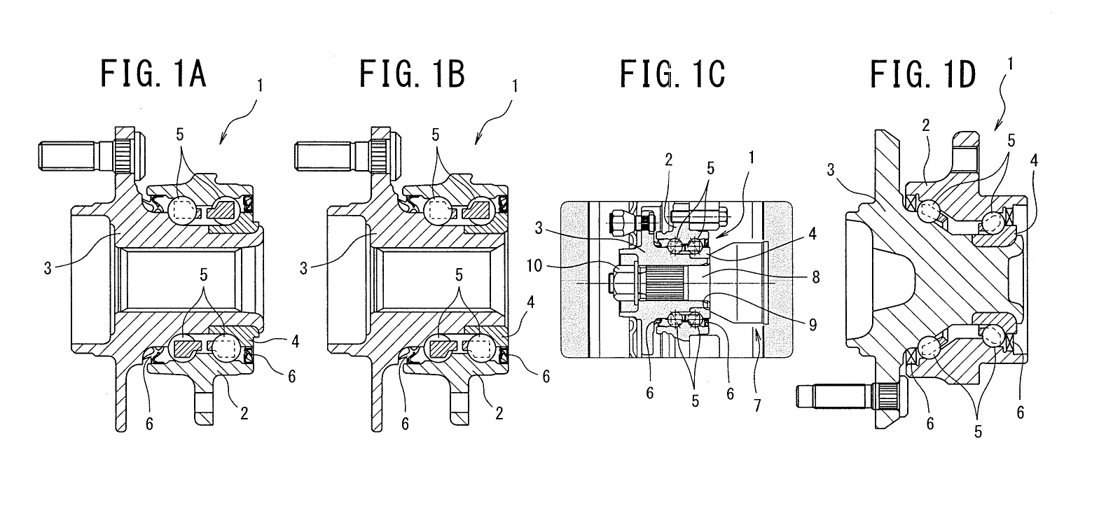

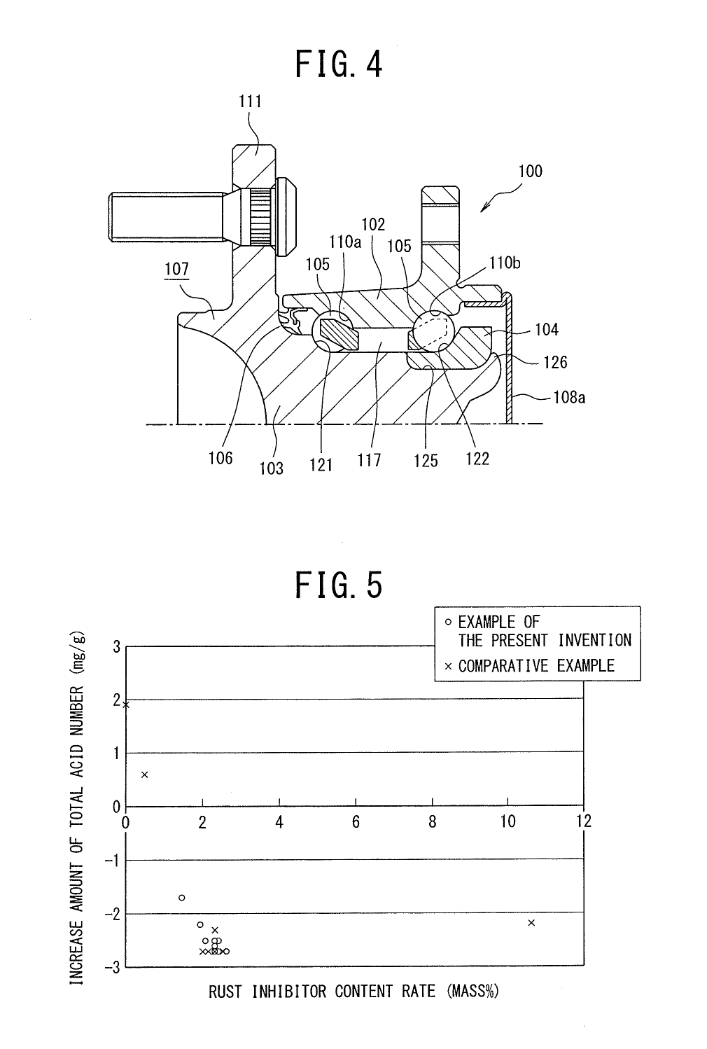

FIGS. 1A to 1D are cross-sectional views illustrating a structure of a third-generation hub unit bearing to which the wheel supporting rolling bearing unit of this embodiment is applicable. FIGS. 1A and 1B illustrate a third-generation driving wheel bearing 1 having a female spline formed at the bore of a hub main body 3 and engageable with the spline of a constant velocity joint, and having a cap 108a illustrated in FIG. 4 replaced with seal rings 6, 6.

The hub unit bearing 1 illustrated in FIG. 1A has an inner ring 4 fastened by caulking as in FIG. 4. On the other hand, the hub unit bearing 1 illustrated in FIG. 1B has an end face of the inner ring 4 abutting a shoulder part 9 of a constant velocity joint 7 as illustrated in FIG. 1C, and has the inner ring 4 fastened by axial tension of a nut 10 of the constant velocity joint 7 fastening a shaft 8 of the constant velocity joint 7 in the pilot cavity of the hub main body 3.

As is well known, the relationship between the tightening torque of a screw and the axial tension varies largely (as a result, preload varies largely). Accordingly, when the grease composition of the above-explained embodiment is applied to the hub unit bearing in the form of FIG. 1B, the further better effects can be accomplished.

On the other hand, FIG. 1D is a cross-sectional view illustrating an example third-generation asymmetrical hub unit bearing for an undriven wheel having a larger PCD (Pitch Circle Diameter) of rolling elements in the outboard row. According to the structure illustrated in FIG. 1D, the rigidity of the bearing is enhanced and the driving stability of an automobile is improved. On the other hand, the packed grease moves in the direction of the outboard row, and thus the lubrication of the inboard row becomes poor as a result, the produced torque at the outboard row increases, and the grease is likely to leak from the seal of the outboard row.

In such a case, however, the grease composition of the above-explained embodiment which maintains the durability and the anti-wear performance, realizes a low torque performance and has an excellent leakage prevention performance can effectively function.

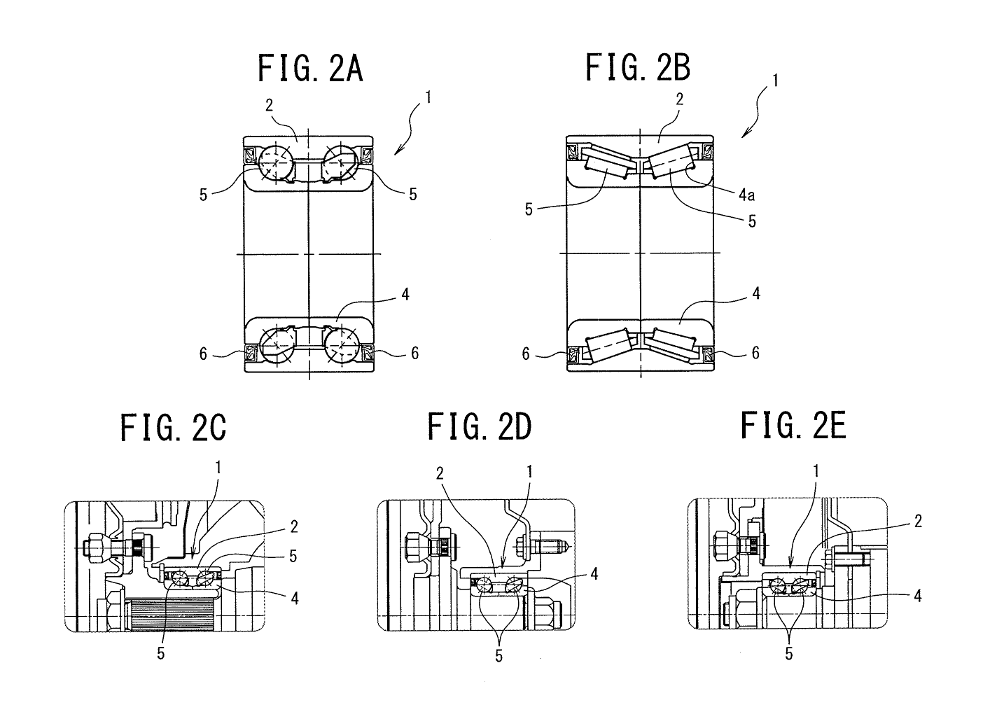

FIGS. 2A to 2E are cross-sectional views illustrating a structure of a first-generation hub unit bearing to which the wheel supporting rolling bearing unit of this embodiment is applicable. FIGS. 2A and 2B illustrate a so-called first-generation hub unit bearing, and as illustrated in FIG. 2C that illustrates a “driving wheel hub unit bearing” and FIGS. 2D and 2e that illustrate an “undriven wheel hub unit bearing”, both inner and outer rings are assembled with actual vehicle components, such as a knuckle or a hub by press fitting, and is used in a fastened condition by a nut.

In the first-generation hub unit bearing illustrated in FIGS. 2A and 2B, engagement and axial tension of the nut act on the preload, and thus the range of the bearing preload after assembled with a vehicle body becomes remarkably widespread. Hence, the variation in the running torque becomes large in association with such a widespread range.

The grease composition of the above-explained embodiment decreases the load sensitivity of the wheel supporting rolling bearing unit with respect to the running torque (decreases the correlation coefficient between the rolling element load and the torque), bringing about a stable low torque to the first-generation hub unit bearing with a widespread preload range.

Moreover, as illustrated in FIG. 2E, the first-generation hub unit bearing to which the wheel supporting rolling bearing unit of this embodiment is applied is also used for an outer ring rotating application.

In general, when the bearing unit is used for an outer ring rotating application, the grease is collected at the outer ring side by centrifugal force, and the lubrication condition of the inner ring side where the surface pressure is high becomes poor. However, the grease composition of the above-explained embodiment can be suitably used for an outer ring rotating application since it has substantially the same effect as an effect of making the oil film thickened.

Furthermore, as illustrated in FIG. 2B, when the bearing is a tapered roller type, a sliding contact occurs between the roller head (rolling element 5) and a cone back face rib 4a, but in such a case, substantially the same effect as an effect of making the oil film thickened by the grease composition of the above-explained embodiment accomplishes a seizing prevention effect.

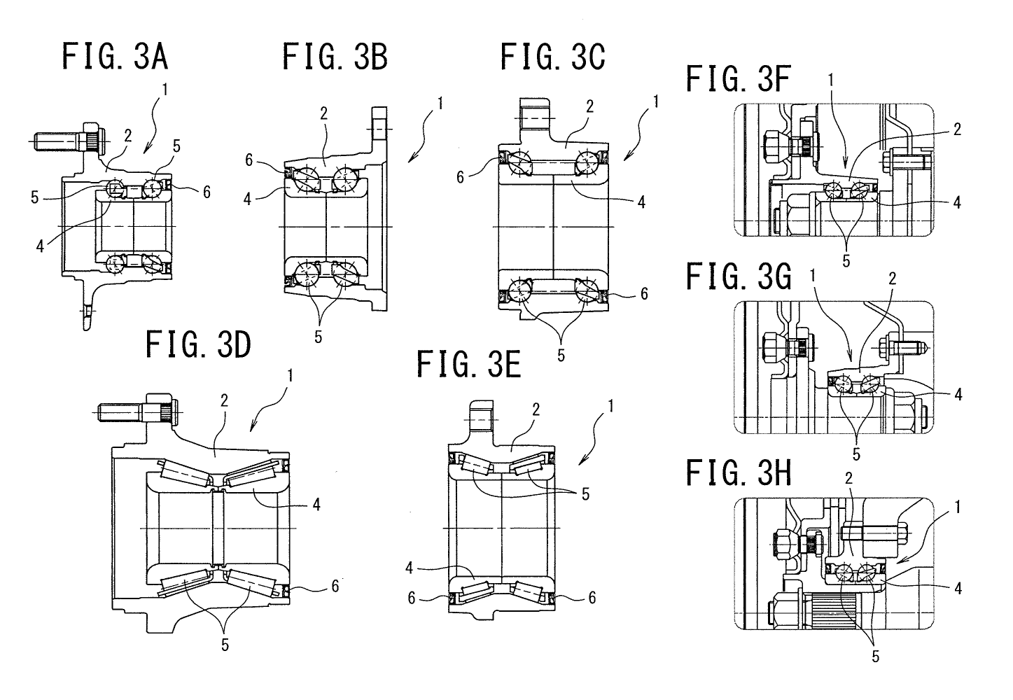

FIGS. 3A to 3H are cross-sectional views illustrating a structure of a second-generation hub unit bearing to which the wheel supporting rolling bearing unit of this embodiment is applicable. FIGS. 3A to 3E illustrate a so-called second-generation hub unit bearing, and as illustrated in FIGS. 3F and 3G that illustrate an “undriven wheel hub unit bearing” and FIG. 3H that illustrates a “driving wheel hub unit bearing”, it employs a structure that incorporates some actual vehicle components into the first-generation hub unit bearing. Accordingly, the preload range becomes narrower than that of the first-generation hub unit bearing, but becomes wider than that of the third-generation hub unit bearing. Moreover, it can be also used for an outer ring rotating application, and thus the same effect as that of the first-generation hub unit bearing can be accomplished.

1. A grease composition comprising: base oil; a thickener; a rust inhibitor; and an anti-wear agent,
the base oil comprising mineral oil, synthetic oil or blend oil of the mineral oil and the synthetic oil, a mix ratio (mass ratio) of the mineral oil and the synthetic oil being 0:100 to 20:80,
wherein a kinematic viscosity of the base oil at a temperature of 40° C. being 70 to 150 mm²/s, and
wherein a pour point of the base oil being equal to or lower than −40° C.

2. The grease composition according to claim 1, wherein
the thickener contains an aromatic-series diurea compound at a content rate of 10 to 40 mass % relative to a total amount of the grease composition and expressed by a following general formula (I),
the rust inhibitor contains a carboxyl-acid-based rust inhibitor, a carboxylate-based rust inhibitor, and an amine-based rust inhibitor, and
the anti-wear agent is triphenyl-phosphorothioate.
R₂—NHCONH—R₁—NHCONH—R₃ General Formula (I)
(in the general formula (I), R₁ is aromatic-series hydrocarbon group with a carbon number of 6 to 15, and R₂ and R₃ are aromatic-series hydrocarbon groups with a carbon number of 6 to 12. R₂ and R₃ may be same or different).

3. The grease composition according to claim 1, wherein
the thickener contains a diurea compound that is at least either one of an alicyclic diurea compound and an aliphatic diurea compound at a content rate of 10 to 30 mass % relative to a total amount of the grease composition and expressed by a following general formula (II),
the rust inhibitor contains a carboxyl-acid-based rust inhibitor, a carboxylate-based rust inhibitor, and an amine-based rust inhibitor, and
the anti-wear agent is triphenyl-phosphorothioate.
R₅—NHCONH—R₄—NHCONH—R₆ General Formula (II)
(in the general formula (I), R₄ is aromatic-series hydrocarbon group with a carbon number of 6 to 15, and R₅ and R₆ are aliphatic hydrocarbon group with a carbon number of 6 to 20 or cyclohexyl derivative group with a carbon number of 6 to 12. R₅ and R₆ have a rate of cyclohexyl derivative group that is 50 to 90 mol % in the total amount of the thickener, and R₅ and R₆ may be same or different).

4. A wheel supporting rolling bearing unit in which the grease composition according to claim 1 is packed.

5. A wheel supporting rolling bearing unit in which the grease composition according to claim 2 is packed.

6. A wheel supporting rolling bearing unit in which the grease composition according to claim 3 is packed.
